(19) United States
(12) Patent Application Publication
(10) Pub. No.: US 2012/0184676 A1
(43) Pub. Date: Jul. 19, 2012

(54) COMPATIBLISED POLYOLEFIN COMPOSITIONS

(75) Inventors: Markus Gahleitner, Neuhofen/Krems (AT); Sara Ronca, Cava de' Tirreni(SA) (IT); Valeria Van Axel Castelli, Rome (IT); Miryam Amore, San Nicola La Strada (CE) (IT); Roberta Cipullo, Naples (IT); Vicenzo Busico, Naples (IT)

(73) Assignee: Stichting Dutch Polymer Institute, Eindhoven (NL)

(21) Appl. No.: 12/733,375

(22) PCT Filed: Aug. 29, 2008
(86) PCT No.: PCT/EP2008/061412

§ 371 Date: Jul. 6, 2011

(30) Foreign Application Priority Data
Aug. 31, 2007 (EP) 07115376.1

(51) Int. Cl. C08L 53/00

(52) U.S. Cl. 525/88

(57) ABSTRACT

Compatibilised polyolefin compositions combining the positive properties of their respective components by using an olefinic di- or triblock copolymer as compatibiliser to generate a finely dispersed phase structure in the molten state and to improve adhesion between the blend components in the solid state, while not compromising processability of the polyolefin composition.

The present invention relates to compatibilised polyolefin compositions, more specifically to compositions comprising at least two chemically different polyolefin components not being miscible in melt and solid state and an olefinic block copolymer as compatibiliser. The invention further relates to the use of an olefinic di- or triblock copolymer as a compatibiliser for polyolefin compositions.

### PRIOR ART

It is well known that chemically different polymers are in general immiscible in the solid state, and frequently also in the molten state. Polymer blends comprising two or more of such immiscible polymers, which are frequently produced to combine the positive properties of the respective polymer components, consequently require the use of compatibilisers. Said compatibilisers should ideally combine a number of features, at least
1. improve compatibility between the blend components in the molten state, thus facilitating the generation of a finely dispersed phase structure in the mixing process applied to produce the blend,
2. improve adhesion between the blend components in the solid state, thus enhancing mechanical strength, and
3. improve processability of the blend, at least by not excessively increasing the melt viscosity of the overall system.

Some of the best known compatibilisers in this respect are regular di- and tri-block copolymers resulting from ionic or living polymerisations. Typical examples of these systems are styrene elastomers, specifically styrene-ethylene-co-butene-(styrene) di- and triblock copolymers (SEB/SEBS). The synthesis of such copolymers can be performed by sequential ionic polymerisation of styrene, butadiene (in combination with isoprene) and, in case of triblocks, again styrene, followed by hydrogenation of the middle block. These systems are frequently limited in their performance by the “hard” segments—in the mentioned case, PS having a Tg limit of ˜95° C. Only few examples of such systems have crystallisable hard blocks and the available chemistry has so far been very limited.

Conventional olefinic “block” copolymers are, in contrast to that, actually a statistical mix of random and block insertions of the respective comonomer, resulting in very complex structures. Even if single-site catalysts have improved that situation somewhat the results from conventional olefin copolymerisation processes are still far away from the regular structures discussed above. Some notable exceptions can be found:
WO 02/66540 A2 claims olefinic block copolymers and a process for their preparation as well as their use as a compatibiliser. Specifically claimed are A-B diblock and A-B-A triblock structures with A being crystalline isotactic polypropylene (iPP) and B an amorphous hydrogenated butadiene and/or isoprene. The copolymers are synthesised in a two- or three-stage process, respectively, where synthesis of the A-blocks is carried out preferably with single-site catalysts but in any case such that a terminal C═C double bond, i.e. a vinyl group, is obtained. The terminating vinyl group is used as starting point for synthesising block B, preferably by anionic polymerisation of dienes like butadiene with the help of a coupling agent, followed by hydrogenation of this block. This procedure is negatively affected in terms of effectiveness by the complex chemistry of the catalyst system resulting from the combination of a coordination catalyst with ionic polymerisation. The respective triblock forms are then again prepared by coupling reactions with bifunctional agents.The compositions described in WO 02/66540 A2 will therefore necessarily contain significant amounts of both non-coupled A-blocks and B-blocks as well as A-B-diblocks in case of the triblock synthesis. These undesired residues will necessarily have a detrimental effect on the compositions' performance as compatibiliser.
U.S. Pat. No. 6,114,443 describes a composition based on blends of polyethylene (PE) and iPP with a diblock copolymer consisting of a PE block and an atactic PP (aPP) block prepared with a metallocene catalyst as compatibiliser. The compatibilisers of this invention are for example prepared using a Cp₂Hf(CH₃)₂ catalyst with a boron-type co-catalyst in a two-stage polymerisation process, first polymerising propylene and then after evacuation and nitrogen purging polymerising ethylene. The resulting polymer had a high molecular weight (Mn ˜250 kg/mol) and a single PE melting point at 119° C.; individual block lengths and purity were not controlled; the existence of a larger fraction of diblocks must be doubted because the Cp₂Hf(CH₃)₂ catalyst is generally not considered to be a living catalyst type. Such polymers will in any case not be capable of co-crystallising with an iPP component. In comparison to a non-compatibilised iPP/HDPE blend only marginal improvements were found.
WO 94/21700 A1 claims block copolymers from ionic catalysts, specifically a process for producing block or tapered ethylene/a-olefin copolymers in a two- or multi-stage polymerisation process with an ionic catalyst system. The examples nominally include EP(R)-b-iPP and EP(R)-b-EP-RACO structures, but the supplied characterisation results clearly show that the obtained products were ofmultiphase /multicomponent nature. The use of said products as compatibiliser is neither described nor claimed.
Weiser et al. (Polymer 47 (2006) 4505-12) describe living random and block copolymerisation of ethene and propene on a phenoxyimine catalyst and the resulting high molecular weight PE-block-P(E-co-P) block copolymers. The diblock copolymers described consist of PE and soft EP-copolymer blocks and are produced by sequential polymerisation. The products are structurally similar to those described in U.S. Pat. No. 6,114,443; catalysts of the described type are not capable of producing iPP blocks.
Jeon et al. (Macromolecules 30 (1997) 973-81) present emulsified (i.e. compatibilised) polyolefin blends based on model polymers—PE, head-head PP and PP/PE diblock copolymer—which are in turn based on hydrogenated butadiene/2,3-dimethylbutadiene copolymers. The structural nature of the described compatibilisers is necessarily random as a consequence of the synthesis procedure.
Ruokolainen et al. (Macromolecules 38 (2005) 851-860) report the polymerisation, morphology and thermodynamic behaviour of diblock copolymers of syndiotactic PP and poly(ethylene-co-propylene (sPP/EPR diblocks). These polymers are based on a titanium-centered bis(phenoxyimine) coordination catalyst and produced by sequential polymerisations. While the diblock structure has been confirmed, the sPP blocks are neither miscible nor capable of cocrystallisation with isotactic PP and thus not functional as a compatibiliser. Only phase segregation in the pure systems was demonstrated.

It was consequently of interest to find a novel way of compatibilising polyolefin blends comprising components not being miscible in the melt state as well as the solid state.

### OBJECT OF THE PRESENT INVENTION

The object for this invention was to develop compatibilised polyolefin compositions combining the positive properties of their respective components and where the mechanical properties of the compatibilised composition are improved compared to the non compatibilised compositions. A further object is that the processability of the polyolefin compositions is not compromised.

### BRIEF DESCRIPTION OF THE PRESENT INVENTION

The above object is achieved by using an olefinic di- or triblock copolymer to generate a finely dispersed phase structure in the molten state and an improved adhesion between the blend components in the solid state. Thus, this invention relates to a novel way of compatibilising polyolefin blends comprising different polyolefin components not being miscible in the melt state as well as the solid state. The use of olefinic di- or triblock copolymers comprising at least one block consisting of monomer units being chemically identical and structurally identically arranged to the monomer units constituting one of the polyolefin components to be compatibilised and wherein the compatibiliser comprises at least one block which is an isotactic propylene homo- or copolymer, was found to be suitable for this.

Recently, Busico et al. (Macromolecules 37 (2004) 8201-3) have presented the possibility to produce iPP with a Zr-centered coordination catalyst with an amine bisphenolate ligand as described for example in WO 02/36638 A2 and EP 1218386 A1. The addition of bulky substituents like adamantyl groups gave well-controlled polymerisation behaviour. With this system, diblock copolymers PE/iPP with well defined melting points for the two phases (129 and 152° C. resp.) could be obtained, but also an essentially statistical EPR. Additionally, it has been found that with hafnium instead of zirconium as central atom the control was even better and the lifetime extended, although at lower activity. This system allows producing iPP/EPR(/iPP) di- and triblock copolymers. According to the present invention, both types of olefinic block copolymers have been found to be suitable and powerful compatibilisers for polyolefin blends, provided that the components and the respective compatibiliser are selected in such a way that miscibility and/or co-crystallisation between the components and the compatibiliser blocks are enabled.

### DETAILED DESCRIPTION OF THE PRESENT INVENTION

The present invention provides a compatibilised polyolefin composition, comprising a crystalline polyolefin component (A), a crystalline or amorphous polyolefin component (B) not being miscible in melt and solid state with (A), and a compatibiliser (C), said compatibiliser being an olefinic block copolymer comprising at least one block consisting of monomer units being chemically identical and structurally identically arranged to monomer units constituting one of the polyolefin components (A) or (B) and wherein the compatibiliser (C) comprises at least one block which is an isotactic propylene homo- or copolymer.

The expression “chemically identical and structurally identically arranged” means that monomers, which are arranged to have a certain type of tacticity in (A) or (B), must be arranged in the same manner in the corresponding block of (C). For example, when (A) comprises an isotactic polypropylene, this condition is fulfilled, because (C) also always comprises an isotactic polypropylene. This requirement is meant to ensure compatibility and miscibility and the possibility for (A) and/or (B) to co-crystallise with (C).

Preferably, the compatibiliser (C) comprises at least one block which is a crystallisable isotactic propylene homo- or copolymer.

Still more preferably, the compatibiliser (C) comprises at least one block which is a crystallisable isotactic propylene homo- or copolymer having a melting point ≧140° C.

The term “crystallisable” refers to a crystallinity of more than 20%, preferably more than 25% of the polyolefin component as determined for example by differential scanning calorimetry, using the maximum melt enthalpy of the respective polyolefin as crystallinity measure (i.e. 100%).

The term “crystalline” refers to a crystallinity of more than 40%, preferably more than 50% of the polyolefin component as determined for example by differential scanning calorimetry, using the maximum melt enthalpy of the respective polyolefin as crystallinity measure (i.e. 100%).

Melting enthalpy for 100% crystalline homo polypropylene is 209 J/g (Brandrup, J., Immergut, E. H., Eds. Polymer Handbook, 3rd ed.; Wiley: New York, 1989; Chapter 3.)

Melting enthalpy for 100% crystalline HDPE is 293 J/g (B. Wunderlich, Macromolecular Physics, Vol. 1, Crystal Structure, Morphology, Defects, Academic Press, New York (1973).

Preferably, the compatibiliser (C) is a di- or triblock copolymer.

Further it is preferred that the polyolefin components (A) and (B) are selected from the group of polyethylene homo- and/or copolymers, polypropylene homo- and/or copolymers and/or olefinic elastomers.

For a preferred composition range for the compatibilised polyolefin composition the polyolefin component (A) is present in an amount of 5 to 95 wt % based on the sum of the weight of (A) +(B), the polyolefin component (B) is present in an amount of 95 to 5 wt % based on the sum of the weight of (A)+(B), and the compatibiliser (C) is present in an amount of 0.1 to 10 wt %, based on the sum of the weight of (A)+(B).

According to a still further preferred embodiment the crystalline polyolefin component (A) is present in an amount of 50-95 wt %, more preferably 60-90, most preferably 70-85 wt % based on the sum of the weight of (A)+(B).

It is more preferred that the compatibiliser (C) is present in an amount of 0.5 to 8 wt %, still more preferably 1-7 wt % based on the sum of the weight of (A) +(B).

According to a preferred embodiment, the compatibilised polyolefin composition is characterised in that the crystalline polyolefin component (A) is an isotactic polypropylene homo- or copolymer and that the polyolefin component (B) is a polyethylene homo- or copolymer.

The used compatibiliser preferably has a M_{w}/Mₙ of ≦2, more preferably of ≦1.8, still more preferably of ≦1.6 and most preferably of ≦1.4. Particularly preferred is a M_{w}/Mₙ of ≦5 1.3.

Such low values for M_{w}/Mₙ are the result of a “controlled polymerisation”. A polymerisation is controlled, when chain initiation is rapid relative to propagation and chain transfer and termination are negligible in the time scale of the experiment.

According to another preferred embodiment, the compatibilised polyolefin composition is characterised in that the crystalline polyolefin component (A) is an isotactic polypropylene homo- or copolymer and that the polyolefin component (B) is an amorphous ethylene a-olefin copolymer or ethylene a-olefin diene terpolymer.

It is required that at least one of the blocks of the compatibiliser (C) is able to co-crystallise with at least one of the polyolefin components (A) and/or (B). For the case of (A) being an isotactic polypropylene homo- or copolymer, the compatibiliser (C) already comprises at least one block which also is an isotactic polypropylene homo- or copolymer block. In case of (B) being a polyethylene homo- or copolymer it is preferred that the compatibiliser (C) comprises at least one block which is a crystallisable polyethylene homo- or copolymer block having a melting point below 140° C.

In order to optimise the processability it is further preferred that the compatibilised polyolefin composition has a zero shear viscosity at 230° C. which is lower than 120% of the zero shear viscosity of the respective polyolefin composition without the compatibiliser.

Suitable compatibilisers (C) can preferably be prepared by sequential polymerisation using a coordination catalyst with an amine bisphenolate ligand and zirconium or hafnium as central metal, as will be outlined in detail below.

A further aspect of the invention is directed to a polyolefin composition, containing as the only polyolefin components, a crystalline polyolefin component (A) and a compatibiliser (C), said compatibiliser being an olefinic block copolymer comprising at least two blocks wherein at least one block consists of monomer units being chemically identical and structurally identically arranged to monomer units constituting the polyolefin component (A) or where at least one block is a crystalline or amorphous polyolefin (B) being immiscible in melt and solid state with (A) and wherein the compatibiliser (C) comprises at least one block which is an isotactic propylene homo- or copolymer.

Such a polyolefin composition is particularly suitable to be used in a blend with a crystalline or amorphous polyolefin (B) wherein the compatibiliser (C) provides the required compatibility with (A).

A still further aspect of the invention is directed to a polyolefin composition, containing as the only polyolefin components, a crystalline or amorphous polyolefin component (B) and a compatibiliser (C), said compatibiliser being an olefinic block copolymer comprising at least two blocks wherein at least one block consists of monomer units being chemically identical and structurally identically arranged to monomer units constituting the polyolefin component (B) or where at least on block is a crystalline polyolefin (A) being immiscible in melt and solid state with (B) and wherein the compatibiliser (C) comprises at least one block which is an isotactic propylene homo- or copolymer.

Such a polyolefin composition is particularly suitable to be used in a blend with a crystalline polyolefin (A) wherein the compatibiliser (C) provides the required compatibility with (B).

Preparation of the Polyolefin Components

As the polyolefin resins (A) and (B) any olefin homo- or copolymers may be provided. However, preferably compositions such as propylene homopolymers, ethylene/propylene random copolymers or heterophasic ethylene/propylene copolymers may be used. Preferably the olefin homo- or copolymers are ethylene or propylene homo- or copolymers. A further group of preferred components are propylene elastomeric copolymers or olefinic elastomers. The polyolefin resins (A) and (B) are selected such that the chemical composition is sufficiently different to cause immiscibility between (A) and (B) in both melt and solid state.

Suitable production processes for the mentioned polyolefins are generally known to those skilled in the art. For the production of polypropylene homo- or copolymers single- or multi-stage polymerisation processes based on a heterogeneous Ti/Mg type catalyst (Ziegler/Natta type) or a metallocene (single-site) type catalyst can be employed. The catalyst system will normally be complemented by a co-catalyst component and, in case of the Ziegler/Natta type, at least one electron donor (internal and/or external electron donor, preferably at least one external donor) controlling the stereoregularity of the produced polymer. Suitable catalysts are in particular disclosed in U.S. Pat. No. 5,234,879, WO 92/19653, WO 92/19658 and WO 99/33843, incorporated herein by reference. Typically the co-catalyst is an Al-alkyl based compound. Preferred internal donors are aromatic esters like benzoates or phthalates, especially preferred are bifunctional esters like diisobutylphtalate. Preferred external donors are the known silane-based donors, such as dicyclopentyl dimethoxy silane or cyclohexyl methyldimethoxy silane.

The mentioned polyethylene homo- or copolymers produced by a single- or multistage process by polymerisation of ethylene, optionally with alpha-olefins like 1-butene, 1-hexene or 1-octene as comonomers for density regulation. Preferably, a multi-stage process is applied in which both the molecular weight and the comonomer content can be regulated independently in the different polymerisation stages. The different stages can be carried out in liquid phase using suitable diluents and/or in gas phase at temperatures of 40-110° C. and pressures of 10 to 100 bar. A suitable catalyst for such polymerisations is either a Ziegler-type titanium catalyst or a single-site catalyst in heterogeneous form. The various possibilities for the production of suitable ethylene homo- and copolymers and suitable catalysts therefor are described in detail in Encyclopedia of Polymer Science and Technology (© 2002 by John Wiley & Sons, Inc.), pages 382-482, the disclosure of which is incorporated herein by reference.

Further representative examples of such polyethylene production processes are for example described in EP 1655339 A1.

The mentioned ethylene propylene elastomeric copolymers or olefinic elastomers may be produced by known polymerisation processes such as solution, suspension and gas-phase polymerisation using conventional catalysts. Ziegler Natta catalysts as well as metallocene catalysts are suitable catalysts.

A widely used process is the solution polymerisation. Ethylene, propylene and catalyst systems are polymerised in an excess of hydrocarbon solvent. Stabilisers and oils, if used, are added directly after polymerisation. The solvent and unreacted monomers are then flashed off with hot water or steam, or with mechanical devolatilisation. The polymer, which is in crumb form, is dried with dewatering in screens, mechanical presses or drying ovens. The crumb is formed into wrapped bales or extruded into pellets.

The suspension polymerisation process is a modification of bulk polymerisation. The monomers and catalyst system are injected into the reactor filled with propylene. The polymerisation takes place immediately, forming crumbs of polymer that are not soluble in the propylene. Flashing off the propylene and comonomer completes the polymerisation process.

The gas-phase polymerisation technology consists of one or more vertical fluidised beds. Monomers and nitrogen in gas form along with catalyst are fed to the reactor and solid product is removed periodically. Heat of reaction is removed through the use of the circulating gas that also serves to fluidise the polymer bed. Solvents are not used, thereby eliminating the need for solvent stripping, washing and drying.

The production of ethylene propylene elastomeric copolymers is also described in detail in e.g. U.S. Pat. No. 3,300,459, U.S. Pat. No. 5,919,877, EP 0 060 090 A1 and in a company publication by EniChem “DUTRAL, Ethylene-Propylene Elastomers” , pages 1-4 (1991). Alternatively, elastomeric ethylene-propylene copolymers, which are commercially available and which fulfil the indicated requirements, can be used.

Preparation of the Compatibiliser

The compatibiliser (C) according to the present invention is an olefinic di- or triblock copolymer. Preferably, such block copolymers are prepared by living or quasi-living sequential polymerisation catalyzed by metal-organic coordination catalysts as described for example in WO 02/36638 A2, EP 1218386 A1 and by Busico et al. in Macromolecules 37 (2004) 8201-3. Preferred are catalysts as shown in FIG. 1, where “Bn” indicates benzyl groups and the substituents R¹ and R² are selected from alkyl, cycloalkyl or aryl groups. Especially preferred are alkyl groups for R² and cumyl or 1-adamantyl groups for R¹. The polymerisations are preferably performed at temperatures between −50 and +50° C. in liquid phase with an unsupported catalyst and a suitable co-catalyst. A preferred co-catalyst is methyl-aluminoxane (MAO), provided that the free trimethyl-aluminium is removed from the reaction system.

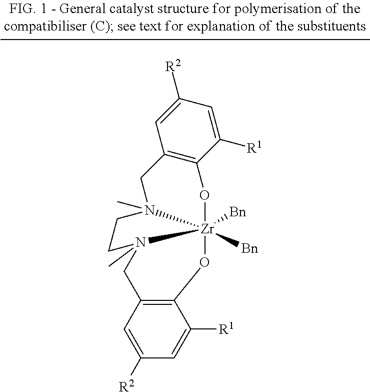

The preparation of a compatibiliser (C) as an olefinic diblock copolymer can then be performed as follows:

1. Polymerisation of a first monomer or a first monomer mixture (time t₁)

2. Degassing of the reactor

3. Polymerisation of a second monomer or a second monomer mixture (t₂)

A further repetition of steps 2 and 3 of this operation results in a triblock copolymer. The respective molecular weight of the two or three blocks may be controlled through the polymerisation times t₁ and t₂.

The polymerisation may preferably be stopped by quenching with acidified methanol. The resulting block copolymer may be coagulated with an excess of a mixture of methanol and hydrochloric acid (CH₃OH/HCl), filtered, washed with more methanol and vacuum-dried. Before utilisation as a compatibiliser it is recommended to stabilise the block copolymer against oxidative degradation with a solution of an antioxidant or a mixture of antioxidants normally applied for the stabilisation of polyolefins. Suitable antioxidants include sterically hindered phenols as primary antioxidants and organophosphites or organophosphonites as secondary antioxidants; suitable solvents are non-polar or polar organic solvents. Especially suitable are mixtures in which Pentaerythrityl-tetrakis(3-(3′,5′-di-tert. butyl-4-hydroxyphenyl)-propionate (trade name Irganox 1010, Ciba Specialty Chemicals) and/or Octadecyl 3-(3′,5′-di-tert. butyl-4-hydroxyphenyl)propionate (trade name Irganox 1076, Ciba Specialty Chemicals) as primary antioxidants are combined with Tris (2,4-di-t-butylphenyl) phosphate (trade name Irgafos 168, Ciba Specialty Chemicals) and/or Tetrakis-(2,4-di-t-butylphenyl)-4,4′-biphenylene-di-phosphonite (trade name Irgafos PEPQ, Ciba Specialty Chemicals) as secondary antioxidants; especially suitable solvents are acetone and/or dichloromethane.

Preparation of the Compatibilised Polyolefin Compositions

The inventive compatibilised polyolefin compositions may be prepared in any conventional mixing process suitable for thermoplastic polymers. Preferably, the inventive compositions are prepared in a continuous or discontinuous melt mixing process in a temperature range from 150 to 350° C. by melt mixing components (A), (B) and (C) as defined herein. Said melt mixing process is preferably performed in a twin screw extruder or single screw co-kneader in a temperature range from 170 to 300° C.

The polyolefin components will normally be added in pure, solid form to the mixing process. The compatibiliser can be added in pure solid form, as a masterbatch in either of the polyolefin components, or in a dryblend with other additives. In any case, the compositions shall be selected such that they comprise 5 to 95 wt % based on the sum of the weight of (A)+(B) of the crystalline polyolefin component (A), 95 to 5 wt % based on the sum of the weight of (A)+(B) of the crystalline or amorphous polyolefin component (B) not being miscible in melt and solid state with (A), the olefinic di- or triblock copolymer (C), which is used to compatibilise the composition. (A), (B) and (C) are in each case as defined herein.

In order to obtain the compatibilised composition, the compatibiliser (C) is preferably used is used in a concentration of 0.1 to 10 wt % based on the sum of weights of (A)+(B).

The melt mixing process may also be used to optionally disperse other additives and modifiers commonly used for the stabilisation and property enhancement of polyolefins at the same time.

Optional Additives and Modifiers

Optionally added suitable additives include processing-, long-term-heat- and UV stabilisers, slip agents, antiblocking agents, antistatic agents, nucleating agents and pigments, preferally not exceeding an overall content of 1 wt %. Furthermore, optionally added suitable modifiers include mineral fillers and/or reinforcing fibers not exceeding an overall content of 30 wt %.

Applications

The compatibilised polyolefin compositions according to this invention may be used preferably for the preparation of extruded, injection molded and blow molded articles. Especially preferred applications include cast films, blown films, fibers, fiber webs and extrusion coated fiber webs.

### EXAMPLES

The present invention will now be further described with reference to the following non-limiting examples and comparative examples.

The following test methods were employed to characterise the polyolefin components, the compatibilisers and the compatibilised polyolefin compositions:
Melt flow rate (MFR): Determined according to ISO 1133 at 230° C. with a load of 2.16 kg for polypropylene and at 190° C. with a load of 2.16 kg for polyethylene.
Mooney viscosity: Determined according to ISO 289-1 at 125° C. with 4 minutes heating time and 1 minute measuring time (ML(1+4)).
Density: Determined according to ISO 1183 on compression moulded specimens.
Differential scanning calorimetry (DSC): Melting temperature (Tₘ), melting enthalpy (Hₘ), crystallisation temperature (T_{c}) and crystallisation enthalpy (H_{c}) were determined by differential scanning calorimetry (DSC) on films according to ISO 3146. T_{c} and H_{c} are determined in the cooling scan, Tₘ and Hₘ in the second heating scan of a sequence heating/cooling/heating of +10/−10/+10 K/min between +20° C. and +220° C.
Melt rheology: A standard rheological characterisation in melt state at 230° C. was carried out in dynamic-mechanical mode and plate-plate geometry according to ISO 6721-10-1999, starting from compression moulded plaques and using a frequency sweep from 400 to 0,001 rad/s. According to the Cox/Merz-relation (Cox and Merz, J. Polym. Sci. 28 (1958) 619 ff.) the complex viscosity η* resulting from storage and loss modulus by

$${η}^{*} = \frac{{( {G}^{′2} + {G}^{″2} )}^{1 / 2}}{{γ}^{′}}$$

can be assumed to be identical to the shear viscosity η(γ′) for ω=γ′; ω here being the frequency and γ′ the shear rate.
Dynamic-mechanical solid state testing (DMTA): The glass transition points as well as the storage modulus G′ at +23° C. were measured using dynamic-mechanical analysis according to ISO 6721-7 on compression molded specimens of 1 mm thickness in the temperature range from −110 to +160° C. at a heating rate of 2° C./min.
Tensile test: All parameters were determined according to ISO 527, determined on dog-bone shape compression moulded specimens of 1 mm thickness as described in EN ISO 1873-2.
Particle size distribution: The method outlined by Poelt et al. in J. Appl. Polym. Sci. 78 (2000) 1152-61 was followed, using a combination of contrasting with ruthenium tetroxide and ultramicrotomy to prepare the specimens from compression moulded plaques of 1 mm thickness. The particle size distribution was determined at a magnification of about 4000 times and the number average particle diameter (dᵣ) was calculated.
Molecular weights, molecular weight distribution (Mn, Mw, MWD): Mw/Mn/MWD are measured by Gel Permeation Chromatography (GPC) according to the following method:
The weight average molecular weight Mw and the molecular weight distribution (MWD=Mw/Mn wherein Mn is the number average molecular weight and Mw is the weight average molecular weight) is measured by a method based on ISO 16014-1:2003 and ISO 16014-4:2003. A Waters Alliance GPCV 2000 instrument, equipped with refractive index detector and online viscosimeter was used with 3×TSK-gel columns (GMHXL-HT) from TosoHaas and 1,2,4-trichlorobenzene (TCB, stabilized with 200 mg/L 2,6-Di tert butyl-4-methyl-phenol) as solvent at 145° C. and at a constant flow rate of 1 mL/min. 216.5 μL of sample solution were injected per analysis. The column set was calibrated using relative calibration with 19 narrow MWD polystyrene (PS) standards in the range of 0.5 kg/mol to 11 500 kg/mol and a set of well characterised broad polypropylene standards. All samples were prepared by dissolving 5-10 mg of polymer in 10 mL (at 160° C.) of stabilized TCB (same as mobile phase) and keeping for 3 hours with continuous shaking prior sampling in into the GPC instrument.

Preparation of the Compatibilisers (Examples a and b)

Two different types of compatibiliser (C) were used, a diblock copolymer (example a) and a triblock copolymer (example b). The preparation of the catalyst as well as the polymerisation will be described here.

Synthesis of the ONNO Ligand

5.0 mmol of N,N′ dimethylethylenediamine, 10.0 mmol of formaldehyde (37% solution in water) and 10.0 mmol of 2,4-bis(α,α-dimethylbenzyl)phenol are added to 30 mL of methanol and kept at reflux for 1 day. The white, crystalline solid that precipitates is the desired product; this is filtered, washed with cold methanol and dried in an oven (at 65° C. under vacuum for 3 h). A second crop of product can be obtained by keeping the methanol solution in a fridge for several days. The total yield was found to be 1.6 g (40%); structure and purity were confirmed by ¹H NMR (200 MHz, CDCl₃).

Synthesis of HfBn₄ (Bn=Benzyl)

Commercially available HfBn₄ usually contains 1-2 mol % of ZrBn₄, which is highly detrimental to our purpose because the homologous Zr based catalyst is much more active than the desired Hf based one and does not show a controlled kinetic behavior. Therefore, a batch of HfBn₄ was synthesised from ultra-pure HfCl₄ (purity 99.9%) according to: Westmoreland I., Synthetic Pages 211, 2003 (www.syntheticpages.com). HfCl₄ (7.7 g, 24.0 mmol) is weighted in a Schlenk flask, suspended in diethyl ether (100 mL, dry, distilled over sodium) and stirred for 1 h. The suspension is then cooled to -78° C. and benzyl magnesium chloride (100 mL, 1.0 M in diethyl ether) is added dropwise over 30 min. The creamy off-white mixture obtained is stirred overnight in the dark, covering the flask with aluminium foil. The solvent is removed under vacuum, and the residue is extracted with warm heptane (3×75 mL). The combined extracts are concentrated to ca. 100 mL and cooled to −30° C. The product is obtained as fine yellow needles after cooling for several hours at this temperature. A yield of 10 g (78%) was determined; structure and purity of the substance were confirmed by ¹H NMR (200 MHz, C₆D₆).

Synthesis of the (ONNO)HfBn₂ Precatalyst (FIG. 2)

5.0 mmol of ligand are weighed in a Schlenk flask and dissolved in 10 mL of dry warm toluene. The resulting solution is added to another Schlenk flask containing a solution of 5.0 mmol of HfBn₄ in 10 mL of the same solvent under argon. The mixture is kept at 65° C. for 2 h, then the solvent is evacuated to give an off-white powder in nearly quantitative yield (5.4 g, 95%). Both ¹H NMR (400 MHz, C₆D₆) and ¹³C NMR (50 MHz, C₆D₆) were applied to confirm structure and purity.

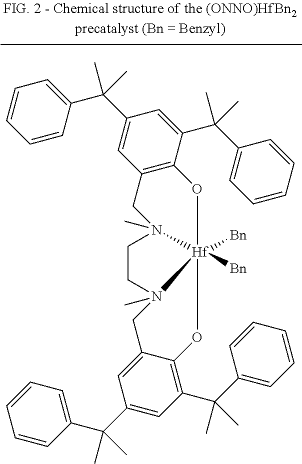

Synthesis of iPP-Block-EPR and iPP-Block-EPR-Block-iPP Copolymers

The block copolymerisation experiments were carried out in a 600 mL magnetically stirred, jacketed Pyrex reactor with three necks (one with a 15 mm SVL joint capped with a silicone rubber septum, another with a 30 mm SVL joint housing a pressure tight fitting for a Pyrex cannula, and the third with a Rotaflo™ joint connected to a Schlenk manifold). A T-joint on top of the cannula allowed connection either to the Schlenk manifold or to a propene cylinder. The Rotaflo™ joint, in turn, was connected to another T-joint that could be switched to the Schlenk manifold or to an ethene cylinder. What follows is a typical procedure. The reactor is charged under nitrogen with 300 mL of dry toluene containing 8.0 mL of MAO (Crompton, 10% w/w solution in toluene) and 2.6 g of 2,6-di-tert-butylphenol (TBP), and thermostated at 25° C. After 1 h (to ensure the complete reaction between TBP and “free” AIMe₃ in equilibrium with MAO), the reactor is evacuated to remove the nitrogen, and the liquid phase is saturated through the cannula with propene at a partial pressure of 2.0 bar, under vigorous magnetic stirring. Once equilibrium is attained, the polymerisation is started by injecting through the silicone septum 173 mg of precatalyst, previously dissolved in 5 mL of the liquid phase (taken out prior to saturation). After three hours, the reactor is degassed and saturated sequentially with propene at a partial pressure of 1.2 bar, and ethene at a partial pressure of 1.0 bar. At this composition of the gas phase, the produced EPR has a composition of 70 mol-% ethene, 30 mol-% propene. The reaction is left to proceed at constant reactor total pressure by continuously feeding ethene, which corresponds to a constant comonomer feeding ratio in the liquid phase because propene consumption is negligible (confirmed by GC analysis of the gas phase in equilibrium). After 1 h, if the targeted product is iPP-b/ock-EPR the reaction is quenched with 5 mL of methanol/HCl (aq, conc.) (95/5 v/v). Otherwise, to go for iPP-block-EPR-block-iPP the reactor is degassed under vacuum and saturated again with propene at a partial pressure of 2.0 bar. After 3 h of further reaction, the system is quenched with acidified methanol. The block copolymer is coagulated with excess methanol/HCI, filtered, washed with more methanol and vacuum-dried. The results for iPP-b/ock-EPR and iPP-b/ock-EPR-b/ock-iPP copolymers are summarised in table 1.

TABLE 1
Characterisation results of block copolymer compatibilisers a (diblock)
and b (triblock)

| | Yield, | Mₙ,^{(a,b)} | | | |
|---|---|---|---|---|---|
| Copolymer | mg | kg/mol | M_{w}/Mₙ | Tₘ,^{(c)} ° C. | ΔHₘ,^{(c)} Jg⁻¹ |
| iPP-block-EPR | 718 | 14.0 | 1.1 | 141.5 | 53.3 |
| iPP-block-EPR- | 1070 | 21.6 | 1.2 | 142.9 | 66.9 |
| block-iPP | | | | | |

^{(a)}Measured by ¹H NMR.
^{(b)}Total Mₙ. iPP block(s): 7.6 kg/mol; EPR block: 6.4 kg/mol.
^{(c)}Measured by DSC on 2^{nd} heating scan.

### Preparation of the Compatibilised Polyolefin Compositions (Examples 1-4, Comparative Examples 5-9)

The following polyolefin materials were used as base polymers (A) and (B), respectively:
HC001 is a crystalline polypropylene homopolymer commercially available from Borealis Polyolefine GmbH, Austria. The polymer has an MFR (230° C./2.16 kg) of 2 g/10 min, a density of 905 kg/m³ and an XS content of 0.5 wt %.
RG7403 is a crystalline medium density polyethylene copolymer commercially available from Borealis Polyolefine GmbH, Austria. The polymer has an MFR (190° C./2.16 kg) of 3.5 g/10 min and a density of 940 kg/m³.
Versify 3200 is an olefinic elastomer copolymer comprising propylene and ethylene, commercially available from The DOW Chemical Company, USA. The elastomer has an MFR (230° C./2.16 kg) of 2 g/10 min, an ethylene content of 12 wt % and a density of 940 kg/m³.
Dutral C0038 is an olefinic elastomer copolymer comprising propylene and ethylene, commercially available from Polimeri Europa, Italy. The elastomer has a Mooney viscosity ML(1+4) at 125° C. of 44, a propylene content of 28 wt % and a density of 860 kg/m³.

Prior to melt mixing, the compatibilisers a and b present in powder form were stabilised with an acetone solution of 1 wt % of Pentaerythrityl-tetrakis(3-(3′,5′-di-tert. butyl-4-hydroxyphenyl)-propionate (trade name Irganox 1010, Ciba Specialty Chemicals) and 1 wt % of Tetrakis-(2,4-di-t-butylphenyl)-4,4′-biphenylen-di-phosphonite (trade name Irgafos PEPQ, Ciba Specialty Chemicals), selecting the amount of solution such that a concentration of 0.1 wt % of each antioxidant component in the final compatibiliser was achieved.

The respective concentrations of the polyolefin components (A) and (B) as well as the compatibiliser (C) are listed in table 2. The melt mixing process was done on a HAAKE PolyDrive 600/610 two-blade kneader (V=69 cm³ with 70% fill level) at 200° C. and 50 rotations/minute; the mixing time was 5 minutes in all cases. The resulting compatibilised polyolefin compositions were investigated in DSC, electron microscopy, melt rheology, DMTA and tensile test as described above; all characterisation results are summarised in table 2.

TABLE 2
Compositions and characterisation results of examples and comparative examples

| | Base | Modifier | | Compatibiliser | | DSC | | | | |
|---|---|---|---|---|---|---|---|---|---|---|
| | polymer | type | amount | type | amount | Tm, PE | Hm, PE | Tm, PP | Hm,PP | Tc, PP |
| Number | — | — | wt % | — | wt % | ° C. | J/g | ° C. | J/g | ° C. |
| Ex. 1 | HC001 | RG7403 | 20 | Diblock a | 5 | 127 | 46 | 162 | 73 | 116 |
| Ex. 2 | HC001 | RG7403 | 20 | Triblock b | 5 | 127 | 45 | 162 | 76 | 116 |
| Ex. 3 | HC001 | Dutral | 20 | Triblock b | 2 | — | — | 161 | 81 | 116 |
| Ex. 4 | HC001 | Dutral | 20 | Triblock b | 5 | — | — | 161 | 86 | 116 |
| CE5 | HC001 | RG7403 | 20 | none | 0 | 127 | 46 | 161 | 73 | 113 |
| CE6 | HC001 | RG7403 | 20 | Dutral | 5 | 126 | 45 | 161 | 70 | 114 |
| CE7 | HC001 | RG7403 | 20 | Versify | 5 | 126 | 46 | 161 | 71 | 113 |
| CE8 | HC001 | Dutral | 20 | none | 0 | — | — | 161 | 88 | 114 |
| CE9 | HC001 | Dutral | 20 | Versify | 5 | — | — | 161 | 76 | 115 |

| | PSD | Viscosity | DMTA | Tensile test | | |
|---|---|---|---|---|---|---|
| | d(N) | 0.1 rad/s | G′(+23° C.) | Modulus | Ext. B | Str. B |
| Number | μm | Pa · s | MPa | MPa | % | MPa |
| Ex. 1 | 1.44 | 2430 | 711 | 1513 | 18.3 | 30.2 |
| Ex. 2 | 0.86 | 2340 | 773 | 1557 | 36.4 | 35.2 |
| Ex. 3 | 0.70 | 4620 | 535 | 1203 | 43.2 | 18.6 |
| Ex. 4 | 0.68 | 4500 | 519 | 1163 | 68.0 | 18.5 |
| CE5 | 1.64 | 1820 | 791 | 1550 | 6.1 | 34.6 |
| CE6 | 2.04 | 2200 | 686 | 1416 | 8.2 | 22.5 |
| CE7 | 0.97 | 3050 | 666 | 1417 | 17.2 | 18.9 |
| CE8 | 1.36 | 4520 | 544 | 1157 | 23.7 | 17.1 |
| CE9 | 0.99 | 4511 | 482 | 1086 | 63.1 | 17.4 |

The results in table 2 show clearly several advantages of the inventive compatibilised polyolefin compositions (examples 1-4) over the comparative polyolefin compositions (comparative examples 5-9):
The phase morphology is clearly improved, expressed by the number average diameter from the particle size distribution.
The stiffness of the compositions, expressed by the storage modulus G′ at +23° C. as well as by the tensile modulus, remains in the same range as for the uncompatibilised compositions. This is in contrast to the compositions with a reference compatibiliser.
The elongation at break as determined in the tensile test is significantly increased, relating to an enhanced mechanical strength at room temperature.
The processability is retained by keeping the melt viscosity in the same range as the uncompatibilised compositions.

1. A compatibilised polyolefin composition, comprising a crystalline polyolefin component (A), a crystalline or amorphous polyolefin component (B) not being miscible in melt and solid state with (A), and a compatibiliser (C), said compatibiliser being an olefinic block copolymer comprising at least two blocks wherein at least one block consists of monomer units being chemically identical and structurally identically arranged to monomer units constituting one of the polyolefin components (A) or (B) and wherein the compatibiliser (C) comprises at least one block which is an isotactic propylene homo- or copolymer, and the compatibiliser (C) has an M_{w}/Mₙ of ≦1.6.

2. A compatibilised polyolefin composition according to claim 1, wherein the compatibiliser (C) is a di- or triblock copolymer.

3. A compatibilised polyolefin composition according to claim 1, wherein the polyolefin components (A) and (B) are selected from the group consisting of ethylene homo- and/or copolymers, propylene homo- and/or copolymers and/or olefinic elastomers.

4. A compatibilised polyolefin composition according to claim 1, further comprising
10 to 90 wt % based on the sum of the weight of (A)+(B) of polyolefin component (A),
90 to 10 wt % based on the sum of the weight of (A)+(B) of polyolefin component (B) and
0.1 to 10 wt % of the compatibiliser (C), based on the sum of the weight of (A)+(B).

5. A compatibilised polyolefin composition according to claim 1, wherein the crystalline polyolefin component (A) is an isotactic propylene homo- or copolymer and that the polyolefin component (B) is an ethylene homo- or copolymer.

6. A compatibilised polyolefin composition according to claim 1, wherein the crystalline polyolefin component (A) is an isotactic propylene homo- or copolymer and that the polyolefin component (B) is an amorphous ethylene alpha-olefin copolymer or ethylene alpha-olefin diene terpolymer.

7. A compatibilised polyolefin composition according to claim 1, wherein the compatibiliser (C) comprises at least one block which is a crystallisable ethylene homo- or copolymer block having a melting point below 140° C.

8. A compatibilised polyolefin composition according to claim 1, wherein the composition has a zero shear viscosity at 230° C. which is lower than 120% of the zero shear viscosity of the respective polyolefin composition without the compatibiliser (C).

9. A compatibilised polyolefin composition according to claim 1, wherein the compatibiliser (C) has been produced by sequential polymerisation using a coordination catalyst with an amine bisphenolate ligand and zirconium or hafnium as central metal.

10. A process for producing a compatibilised polyolefin composition, in that wherein a crystalline polyolefin component (A), a crystalline or amorphous polyolefin component (B) not being miscible in melt and solid state with (A), and a compatibiliser (C), said compatibiliser (C) being an olefinic block copolymer having an M_{w}/Mₙ of ≦1.6 and comprising at least one block consisting of monomer units being chemically identical and structurally identically arranged to the monomer units constituting one of the polyolefin components (A) or (B) are melt mixed in a temperature range of from 150 to 350° C.

11. Process according to claim 10, wherein the melt mixing is performed in a twin screw extruder or single screw co-kneader in a temperature range from 170 to 300° C.

12. Use of a compatibilised polyolefin composition according to claim 1 for the manufacture of extruded, injection moulded or blow moulded articles.

13. Use of a compatibilised polyolefin composition according to claim 1 for the manufacture of cast films, blown films, fibers, fiber webs and extrusion coated fiber webs.

14. Use of an olefinic di- or triblock copolymer (C) to compatibilise a polyolefin composition comprising 5 to 95 wt % of a crystalline polyolefin component (A) based on the sum of the weight of (A)+(B) and 95 to 5 wt % based on the sum of the weight of (A)+(B) of a crystalline or amorphous polyolefin component (B) not being miscible in melt and solid state with (A), said compatibiliser (C) being an olefinic block copolymer comprising at least one block consisting of monomer units being chemically identical and structurally identically arranged to the monomer units constituting one of the polyolefin components (A) or (B) and wherein the compatibiliser (C) comprises at least one block which is an isotactic propylene homo- or copolymer, and the compatibiliser (C) has an M_{w}/Mₙ of ≦1.6.

15. Use according to claim 14, wherein the olefinic di- or triblock copolymer (C) is used in a concentration of 0.1 to 10 wt % based on the sum of weights of (A)+(B).

16. Use according to claim 15, wherein the olefinic di- or triblock copolymer (C) has been produced by sequential polymerisation using a coordination catalyst with an amine bisphenolate ligand and zirconium or hafnium as central metal.

17. A polyolefin composition, containing as the only polyolefin components, a crystalline polyolefin component (A) and a compatibiliser (C), said compatibiliser (C) being an olefinic block copolymer comprising at least two blocks wherein at least one block consists of monomer units being chemically identical and structurally identically arranged to monomer units constituting the polyolefin component (A) or where at least one block is a crystalline or amorphous polyolefin (B) being immiscible in melt and solid state with (A) and wherein the compatibiliser (C) comprises at least one block which is an isotactic propylene homo- or copolymer, and the compatibiliser (C) has an M_{w}/Mₙ of ≦1.6.

18. A polyolefin composition, containing as the only polyolefin components, a crystalline or amorphous polyolefin component (B) and a compatibiliser (C), said compatibiliser (C) being an olefinic block copolymer comprising at least two blocks wherein at least one block consists of monomer units being chemically identical and structurally identically arranged to monomer units constituting the polyolefin component (B) or where at least on block is a crystalline polyolefin (A) being immiscible in melt and solid state with (B) and wherein the compatibiliser (C) comprises at least one block which is an isotactic propylene homo- or copolymer, and the compatibiliser (C) has an M_{w}/Mₙ of ≦1.6.
